(19) United States
(12) Patent Application Publication
(10) Pub. No.: US 2008/0244499 A1
(43) Pub. Date: Oct. 2, 2008

(54) APPARATUS AND DESIGN METHOD FOR CIRCUIT OF SEMICONDUCTOR DEVICE ETC

(75) Inventor: Hiroaki HANAMITSU, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/135,579

(22) Filed: Jun. 9, 2008

Related U.S. Application Data
(63) Continuation of application No. PCT/JP2005/022661, filed on Oct. 9, 2005.

(51) Int. Cl. G06F 17/50

(52) U.S. Cl. 716/15

(57) ABSTRACT

A design apparatus comprises a unit generating a new-via-formable overlapped area between a first wiring pattern and a second wiring pattern by extending, in a predetermined direction, at least one of the first wiring pattern included in a first wiring layer and the second wiring pattern connected by a via to the first wiring pattern and included in a second wiring layer thereof, and a unit determining whether or not there is a predetermined interval between the first extended wiring pattern and a wiring pattern existing in the periphery of the first wiring pattern in each of the first wiring layer including the first extended wiring pattern and the second wiring layer including the second extended wiring pattern, and determining whether or not there is a predetermined interval between the second extended wiring pattern and a wiring pattern existing in the periphery of the second wiring pattern.

### CROSS-REFERENCE TO RELATED APPLICATIONS

This is a continuation of Application PCT/JP2005/022661 filed on Dec. 9, 2005, now pending, the contents of which are herein wholly incorporated by reference.

### BACKGROUND OF DISCLOSURE

The present invention relates to a design support apparatus, a design support method and a design support program for supporting a layout design of a circuit of a semiconductor device etc.

With an advancement of a multi-layered structure of the semiconductor device, a wiring of an upper layer and a wiring of a lower layer, which are formed on different wiring layers, are connected by use of a conductive layer called a via and electrically connected by this via. Therefore, an electric signal is transmitted to the wiring of the lower layer (which will hereinafter simply be termed a lower-layer wiring) from the wiring of the upper layer (which will hereinafter simply be termed an upper-layer wiring) through the via or transmitted to the upper-layer wiring from the lower-layer wiring through the via.

The single via has hitherto been disposed between the upper-layer wiring and the lower-layer wiring. With micronization of the process, however, the vias also come to be micronized. Consequently, a stress applied onto the via reaches an undurable level simply by disposing one via, and an increased possibility is that a via-disconnected phenomenon occurs. A thinkable counter-scheme for reducing the occurrence possibility of the defect caused by the via-disconnection is that the via is given redundancy by dualizing the via disposition, i.e., two vias are disposed between the upper-layer wiring and the lower-layer wiring. In this counter-scheme, even if one of the two vias is disconnected, the conduction between the upper-layer wiring and the lower-layer wiring can be kept by the other via, and the electric signal is transmitted between the upper-layer wiring and the lower-layer wiring.

Herein, the dualization of the via-disposition is referred to as via redundancy. Implementation of the via redundancy entails extending any one or both of the upper-layer wiring and the lower-layer wiring, corresponding to a layout of the respective wirings. The wiring can not be extended unconditionally, and the extension of the wiring undergoes restrictions from another wiring (a signal line etc) existing in the periphery of the wiring to be extended. These restrictions are normally defined as a design rule.

The design rule defines items such as prescribing a minimum via-to-via interval on the order of μm and prescribing a wiring-to-wiring interval on the order of μm, and is provided to a designer. Further, the designer is provided also with a design rule checker (DRC) for checking whether the wiring layout of the semiconductor device breaks the design rule or not and for specifying a rule-breaking position. When the designer designs the wiring layout, such a case exists that a breach of the layout design might be detected by a check of the DRC. If the DRC detects the breach of the layout design, a layout edit for removing a factor of the breach is conducted. Then, the layout edit is repeatedly performed till none of the breach of the layout design is detected by the check of the DRC. The check of the DRC and the layout edit might be repeatedly executed several times.

The layout edit for the via redundancy similarly has a possibility of repeatedly performing the check of the DRC and the layout edit. Note that Patent document 1 given below discloses a semiconductor device with a less of contact defect between the wiring and a contact. Further, Patent document 2 given below discloses a design support apparatus for supporting a layout design for laying out objects on a multi-layered circuit board having a plurality of disposing faces.

[Patent document 1] Japanese Patent Laid-Open Publication No. 2001-85614

[Patent document 2] Japanese Patent Laid-Open Publication No. 2002-342397

### SUMMARY

The related arts are incapable of detecting whether or not, in the case of implementing the via redundancy, this implementation breaches the layout design before conducting the check of the DRC. Therefore, the repetitive executions of the check of the DRC and the layout edit could not be avoided. The present invention aims at providing a technique for detecting a non-breach position against the layout design, in which a new via can be disposed, before making the check of the DRC.

The present invention adopts the following means in order to solve the problems given above.

(1) Namely, a design apparatus (the present design apparatus) for a semiconductor device according to the present invention, comprises: a unit generating a new-via-formable overlapped area between a first wiring pattern and a second wiring pattern by extending, in a predetermined direction, at least one of the first wiring pattern included in a first wiring layer of the semiconductor device and the second wiring pattern connected by a via to the first wiring pattern and included in a second wiring layer thereof; and a unit determining whether or not there is a predetermined interval between the first extended wiring pattern and a wiring pattern existing in the periphery of the first wiring pattern in each of the first wiring layer including the first extended wiring pattern and the second wiring layer including the second extended wiring pattern, and determining whether or not there is a predetermined interval between the second extended wiring pattern and a wiring pattern existing in the periphery of the second wiring pattern.

With this configuration, it may be determined without conducting a check of DRC whether or not there is the predetermined interval between the extended wiring pattern and another wiring pattern existing in the periphery of the extended wiring pattern. It is therefore feasible to determine whether or not the interval between the extended wiring and another wiring existing in the periphery thereof does not breach the design rule before performing the check of the DRC.

(2) The present design apparatus may further comprise: a unit recording, if there is the predetermined interval between the first extended wiring pattern and the wiring pattern existing in the periphery of the first wiring pattern, the new-via-formable overlapped area between the first wiring pattern and the second wiring pattern; and a unit displaying the recorded new-via-formable overlapped area between the first wiring pattern and the second wiring pattern. This configuration enables a designer to recognize a new-via-formable position that does not breach the design rule.

Further, the present invention may be a method by which a computer, other devices, machines, etc execute any one of the processes described above. Still further, the present invention may also be a program that makes the computer, other devices, machines, etc realize any one of the functions described above. Yet further, the present invention may also be a recording medium recorded with such a program readable by the computer etc.

According to the present invention, it is possible to detect the non-breach position against the layout design, in which the new via can be disposed, before conducting the check of the DRC.

### BRIEF DESCRIPTION OF THE DRAWINGS

FIG. 1 is a block diagram of hardware of the present design apparatus.

FIG. 2 is a diagram showing function blocks of a design rule check function provided in the present design apparatus.

FIG. 3A is a plan view of the semiconductor device.

FIG. 3B is a view showing the semiconductor device illustrated in FIG. 3A as viewed from between A1-A2 when the semiconductor device is cut by a solid line X1-X2 in FIG. 3A.

FIG. 4 is an explanatory view showing a case in which the design apparatus performs the design rule check with respect to candidate positions.

FIG. 5A is a plan view illustrating a state in which the new via is disposed in the candidate position B determined in FIG. 4.

FIG. 5B is a view showing the semiconductor device illustrated in FIG. 5A as viewed in directions of arrowheads A1-A2 when the semiconductor device is cut by a solid line X1-X2 in FIG. 5A.

FIG. 6 is an explanatory view showing a case in which an upper-layer wiring 22 and a lower-layer wiring 23 undergo a restriction from another wiring.

FIG. 7 is an explanatory view of a layout screen.

FIG. 8 is a flowchart showing an operating procedure of the design rule check function included in the design apparatus.

### DETAILED DESCRIPTION

A design apparatus according to a best mode (which will hereinafter be termed an embodiment) for carrying out the present invention will hereinafter be described with reference to the drawings. A configuration in the following embodiment is an exemplification, and the present invention is not limited to the configuration in the embodiment.

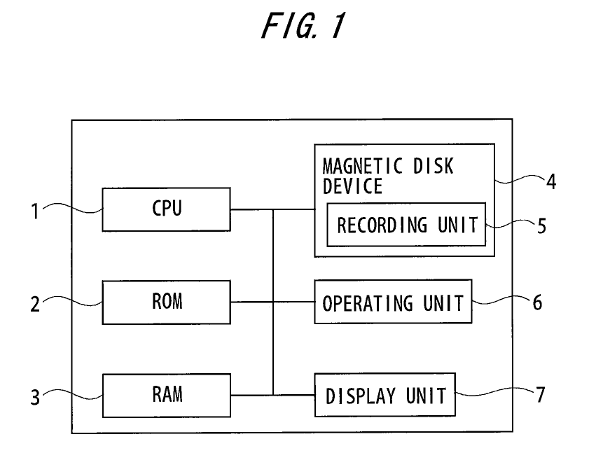

FIG. 1 is a diagram of hardware blocks of the design apparatus. As illustrated in FIG. 1, the design apparatus is constructed of a CPU (Central Processing Unit) 1, a ROM (Read Only Memory) 2, a RAM (Random Access Memory) 3, a magnetic disk device 4, an operation unit 6 and a display unit 7. These components are connected to each other via a bus.

The CPU 1 executes a variety of processes based on programs stored in the ROM 2. The ROM 2 is stored with the programs and parameters necessary for the design apparatus to function. The RAM 3 is temporarily stored with an OS (Operating System) program and part of application programs, which are executed by the CPU 1. The magnetic disk device 4 is used as an external storage for the RAM 3. Further, the magnetic disk device 4 includes a recording unit 5. The operation unit 6 is, e.g., a keyboard, a mouse, etc and is operated when inputting a predetermined command and a necessary item of data. The display unit 7 includes a display device such as a CRT (Cathode Ray Tube), a liquid crystal display and a plasma display, a voice output device such as a loudspeaker, and an output device such as a printer.

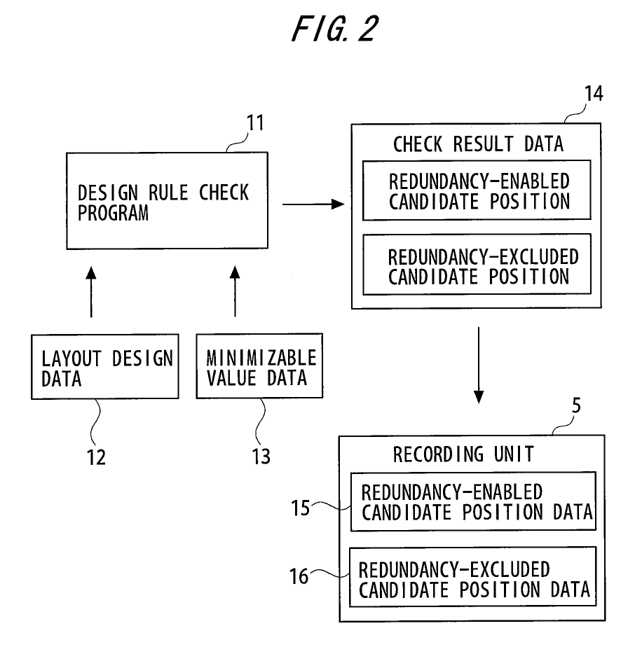

FIG. 2 is a diagram showing function blocks of a design rule check function included in the design apparatus. As illustrated in FIG. 2, the design apparatus has a design rule check program 11. The design rule check program 11 is defined as an application program, which is loaded into the RAM 3 from the magnetic disk device 4 and is execution-controlled by the CPU 1. Then, the design rule check program 11, if based on such a hypothesis that a via is disposed in a candidate position, checks whether or not a predetermined or longer distance is secured as an interval between a wiring to be extended and another wiring existing in the periphery of the candidate position. The “candidate position” connotes, if based on the assumption that any one or both of an upper-layer wiring and a lower-layer wiring are extended for via redundancy (via dualization), a position in which a via (which will hereinafter be also called a new via) for connecting the upper-layer wiring to the lower-layer wiring is disposed.

Herein, it is feasible to previously set a check target wiring existing in the periphery of the candidate position, which wiring undergoes the check about whether or not the predetermined or longer distance is secured as the interval from the wiring to be extended. There is nothing undergoing a restriction even when extending a via redundancy target wiring owing to a scheme of setting the check target wiring beforehand, in other words, another wiring, which does not hinder the via redundancy, can be excluded previously from the check target. Accordingly, in the case of extending the via redundancy target wiring, only another wiring having a possibility of its being subjected to the restriction on the occasion of structuring the via redundancy can be set as the check target.

The design rule check program 11 executes the check on the basis of layout design data 12 and minimizable value data 13, and outputs check result data 14. The layout design data 12 contains data for a layout design of a semiconductor device, data that represents the wiring layer of the semiconductor device, and so on. Further, the minimizable value data 13 represents, on the assumption that the via is disposed in the candidate position by extending the via redundancy target wiring, a minimizable value defined as a minimum distance at which the extended wiring is not restricted by another wiring in the periphery thereof. The minimizable value is determined by standards of the design rule check.

The check result data 14 has pieces of information on a redundancy-enabled candidate position and a redundancy-excluded candidate position. Herein, the “redundancy-enabled candidate position” connotes a candidate position exhibiting a larger interval, than the minimizable value, between the extended via redundancy target wiring and another wiring existing in the periphery of this extended wiring. Moreover, the “redundancy-excluded candidate position” connotes a candidate position exhibiting a smaller interval, than the minimizable value, between the extended via redundancy target wiring and another wiring existing in the periphery of the extended wiring. The redundancy-enabled candidate position is recorded as redundancy-enabled candidate position data 15 on the recording unit 5. Further, the redundancy-excluded candidate position is recorded as redundancy-excluded candidate position data 16 on the recording unit 5.

The layout design data 12 and the minimizable value data 13 are processing data retained beforehand by the magnetic disk device 4. The check result data 14 is data of a result of the execution made by the design rule check program 11 and is recorded on the magnetic disk device 4.

### WORKING EXAMPLE

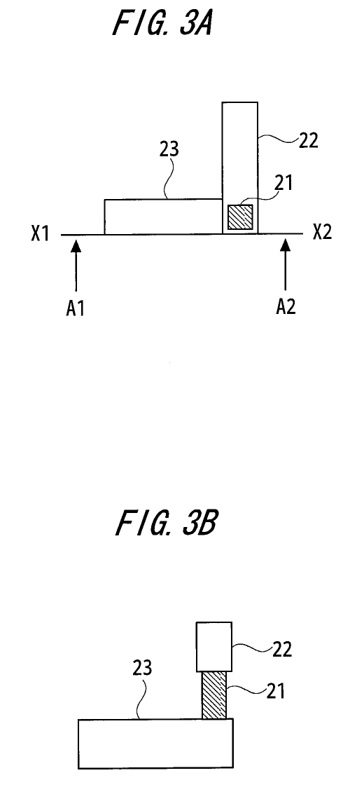

One working example, into which the present invention is embodied, will hereinafter be described with reference to the drawings. FIG. 3A is a plan view of the semiconductor device. FIG. 3B is a view showing the semiconductor device illustrated in FIG. 3A as viewed from between A1-A2 when the semiconductor device is cut by a solid line X1-X2 in FIG. 3A. The semiconductor device shown in FIG. 3A and 3B includes a single via 21, an upper-layer wiring 22 and a lower-layer wiring 23 that are connected at their terminations to the via 21. The via 21 is a conductor plug formed in an inter-layer film in order to establish an electrical connection between the vertically neighboring wirings in a multi-layer wiring structure of the semiconductor device. The upper-layer wiring 22 and the lower-layer wiring 23 are the wirings (signal lines), which electrically connect elements to each other and function for transmitting signals in the semiconductor device.

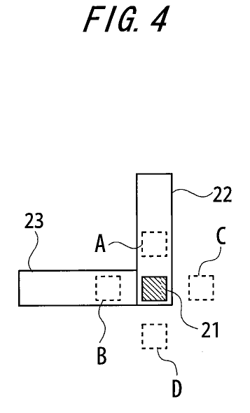

A process, which is executed for adding a redundancy-structured (dualized) via to the semiconductor device illustrated in FIG. 3A and 3B, will hereinafter be described. FIG. 4 is an explanatory view of a processing procedure in which the design apparatus performs the design rule check with respect to the candidate position.

On the occasion of executing a via redundancy structuring process, as shown in FIG. 4, positions A-D are detected and determined as the candidate positions for forming the new vias for the upper-layer wiring 22 and the lower-layer wiring 23 connected to each other by the via 21. Then, the design rule check is carried out for each of the candidate positions A-D. If nothing breaks the design rule, the new via may be disposed in the rule-complying position. An in-depth description of the design rule check will be explained later on. Note that the determination of the candidate positions A-D may involve setting predetermined intervals between the respective candidate positions A-D and the via 21. Further, FIG. 4 illustrates an example where the candidate positions A-D are disposed on an extension line of the upper-layer wiring 22 or the lower-layer wiring 23.

Next, the design rule check will be described. To begin with, as illustrated in FIG. 4, the new vias are virtually disposed in the determined candidate positions A-D, and an assumption is that any one or both of the upper-layer wiring 22 and the lower-layer wiring 23 are extended for connecting the upper-layer wiring 22 and the lower-layer wiring 23 to each other by the new via. Then, a distance between the extended upper-layer wiring 22 or the lower-layer wiring 23 and another wiring existing in the periphery of the candidate position, is calculated with respect to each candidate position. In this case, the target wiring about which the distance from the extended wiring is calculated is another wiring provided on the same layer as the extended wiring exists. For example, if only the upper-layer wiring 22 is extended, the distance between another wiring provided on the same layer as the upper-layer wiring 22 exists and the upper-layer wiring 22, is calculated.

Next, it is determined whether or not the distance between the extended wiring and another wiring is smaller than the minimizable value with respect to each candidate position. If the calculated distance is smaller than the minimizable value, the candidate position provided corresponding to the extended wiring is set as a redundancy-excluded candidate position. Whereas if the calculated distance is larger than the minimizable value, the candidate position provided in the extended wiring is set as a redundancy-enabled candidate position. Thereafter, the redundancy-enabled candidate position is recorded. The redundancy-excluded candidate position is also recorded but is not used for the final via redundancy structuring process, and hence it may be determined according to the necessity whether the record of the redundancy-excluded candidate position is required or not. Along with this scheme, there are also recorded wiring data of the wiring extended corresponding to the redundancy-enabled candidate position and data about an overlapped region between the extended wiring and another wiring.

Another wiring does not exist in the peripheries of the candidate positions A-D illustrated in FIG. 4. In other words, the example in FIG. 4 leads to judgment that the distance between another wiring in the periphery of each candidate position and the extended wiring is larger than the minimizable value. Therefore, the new via can be disposed in any one of the candidate positions A-D without any non-compliance with the design rule showing the relation with the peripheral wirings in FIG. 4.

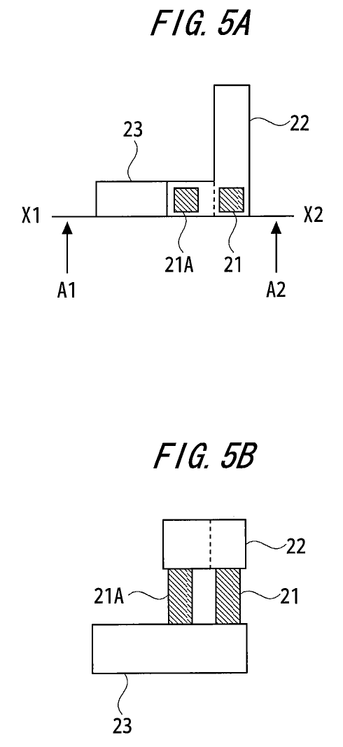

FIG. 5A and 5B are an explanatory view of a procedure of disposing the new via in the candidate position after the design rule check has been conducted by the technique in FIG. 4. FIG. 5A is a plan view illustrating a state in which the new via is disposed in the candidate position B determined in FIG. 4. Further, FIG. 5B is a view showing the semiconductor device illustrated in FIG. 5A as viewed in directions of arrowheads A1-A2 when the semiconductor device is cut by a solid line X1-X2 in FIG. 5A. Note that because of there being no restriction against the via redundancy, the candidate position to be determined is set arbitrary in the example of FIG. 4, and any inconvenience may not be caused by determining other candidate positions. The candidate positions may be selected based on an operation by the operator.

As illustrated in FIG. 5A and 5B, if the candidate position B is determined by the technique in FIG. 4, a process of extending the upper-layer wiring 22 toward the candidate position B is executed. An example of FIG. 5A and 5B shows that the upper-layer wiring 22 is bent at 90 degrees from the position of the via 21 and then extended. Subsequently, a process of adding a new via 21a to the candidate position B is carried out. Data about the thus-added new via 21a is recorded as part of the wiring data. Through these processes, the two vias, i.e., the via 21 and the new via 21a, are disposed between the upper-layer wiring 22 and the lower-layer wiring 23, whereby the via disposition can be dualized for having the redundancy. Note that a region between the via 21 and the new via 21a corresponds to the wiring-overlapped region in FIG. 5A and 5B.

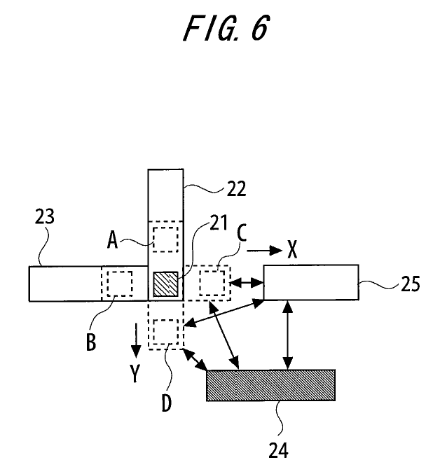

FIG. 6 is an explanatory view showing a procedure of the determination of the candidate positions through the formation of the new via if the upper-layer wiring 22 and the lower-layer wiring 23 each serving as the via redundancy target wiring undergoes the restriction from another wiring. As shown in FIG. 6, if another wiring exists in the periphery of the candidate position, the formation of the redundant via undergoes the restriction from another wiring in terms of the design rule.

In the example of FIG. 6 also, the vias are virtually disposed in the respective candidate positions, and the process of extending the wirings is executed. For example, when the new via is disposed in the candidate position C in FIG. 6, the upper-layer wiring 22 and the lower-layer wiring 23 are mutually extended in the X-direction. Then, there are calculated a distance between the extended upper-layer wiring 22 and another upper-layer wiring 24 peripheral thereto and a distance between the extended lower-layer wiring 23 and another lower-layer wiring 25 peripheral thereto. This process is properly conducted for other candidate positions.

Next, it is determined whether the calculated distance between the respective wirings is smaller than the minimizable value or not. If the calculated distance is smaller than the minimizable value, the corresponding candidate position is set as the redundancy-excluded candidate position. The example of FIG. 6 shows that another wiring 24 and still another wiring 25 exist in the periphery of the candidate position C. Herein, if at least one of the distance between the extended upper-layer wiring 22 and the wiring 24 and the distance between the extended lower-layer wiring 23 and the wiring 25 is judged to be smaller than the minimizable value, the candidate position C is set as the redundancy-excluded candidate position.

On the other hand, when the new via is disposed in the candidate position D in FIG. 6, neither the upper-layer wiring 22 nor the lower-layer wiring 23 is disposed in the candidate position D. Accordingly, the upper-layer wiring 22 and the lower-layer wiring 23 are extended in the Y-direction toward the candidate position D. Calculated then are a distance between the extended upper-layer wiring 22 and another upper-layer wiring 24 peripheral thereto and a distance between the extended lower-layer wiring 23 and another lower-layer wiring 25 peripheral thereto. Next, it is determined whether the calculated distance is smaller than the minimizable value or not. If the distance calculated with respect to candidate position D is determined to be smaller than the minimizable value, the candidate position D is set as the redundancy-excluded candidate position.

The candidate position A is located in the region where the upper-layer wiring 22 is formed, and hence the lower-layer wiring 23 is extended in a way that bends the lower-layer wiring 23 at 90 degrees toward the candidate position A. Thereafter, the distance between the upper-layer wiring 22 and another wiring existing in the periphery of the lower-layer wiring 23 is calculated. In the example of FIG. 6, another wiring does not exist in the periphery of the candidate position A, and it is therefore determined that the calculated inter-wiring distance is larger than the minimizable value. As a result, the candidate position A is set as the redundancy-enabled candidate position. The candidate position B is likewise set as the redundancy-enabled candidate position.

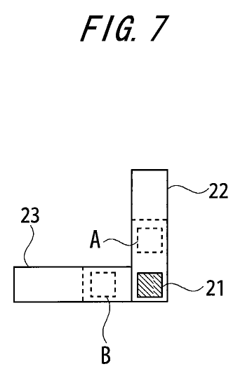

Thus, in FIG. 6, the candidate positions A and B are set as the redundancy-enabled candidate positions, while the candidate positions C and D are set as the redundancy-excluded candidate positions. In this case, a circuit showing the redundancy-enabled candidate positions as illustrated in FIG. 7 is displayed on a layout screen. Namely, as illustrated in FIG. 7, the redundancy-excluded candidate position D does not become the via redundancy candidate position and is not therefore displayed because of its being excluded. Similarly, the redundancy-excluded candidate position C is excluded and is thus not displayed. While on the other hand, the redundancy-enabled candidate positions A and B are displayed as the candidate positions on the layout screen. Then, the designer may select any one of the candidate positions A and B, which are displayed on the layout screen, as the position where the new via is actually disposed. The DRC (Design Rule Checker) is executed by selecting the candidate position A or B in which the via is actually disposed, even in which case this does not break the design rule.

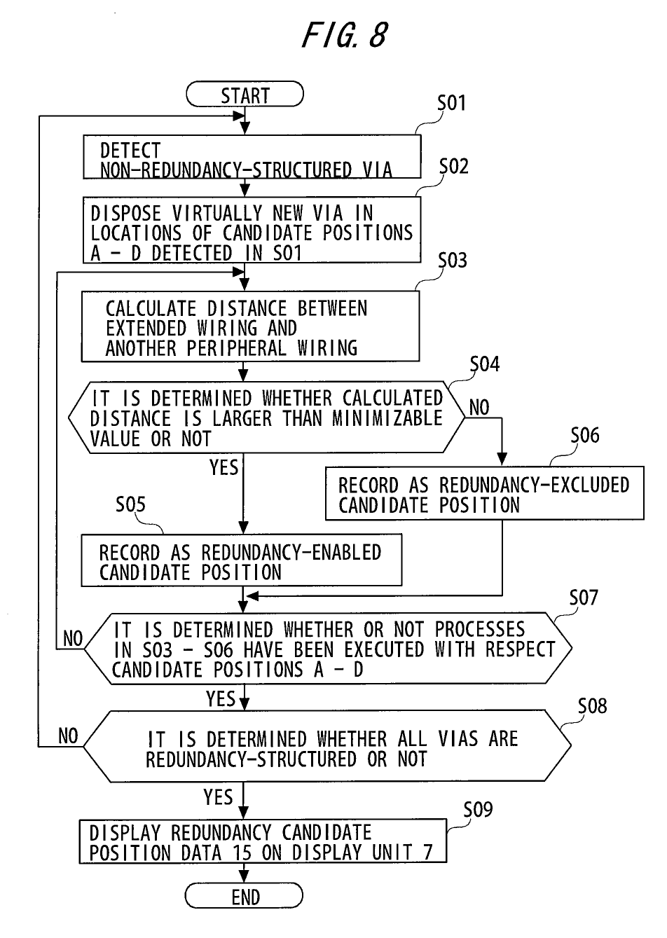

FIG. 8 is a flowchart showing an operating procedure of the design rule check function possessed by the design apparatus. The design apparatus, at first, detects the non-redundancy via (that is not yet dualized in terms of the via disposition) among the vias provided in the layout design target semiconductor device (S01).

Next, with respect to the detected via, the candidate positions (A-D illustrated in FIG. 4) are, as illustrated in FIG. 4, detected as the positions in which the new via is to be disposed. For example, the position in which to dispose the new via is detected in directions of 0 degree, 90 degrees, 180 degrees and 270 degrees to the wiring directions of the wirings connected by the via from the position of the now-already-formed via. Note that the conditions for setting the locations and the number of the candidate positions may be properly changed corresponding to the layout relation between the upper-layer wiring and the lower-layer wiring. Then, the new via is virtually disposed in each of the detected candidate positions A-D (S02).

Subsequently, the distance between the wiring extended toward the via virtually disposed in the process in S02 and another wiring existing in the periphery thereof, is calculated (S03). Next, it is determined whether the distance calculated about the candidate position is larger than the minimizable value or not (S04). If the calculated distance is larger than the minimizable value, the candidate position is set as the redundancy-enabled candidate position. Then, the redundancy-enabled candidate position is recorded as the redundancy-enabled candidate position data 15 on the recording unit 5 (S05). Whereas if the calculated distance is smaller than the minimizable value, the candidate position is set as the redundancy-excluded candidate position. Then, the redundancy-excluded candidate position is recorded as the redundancy-excluded candidate position data 16 on the recording unit 5 (S06).

Then, it is determined whether or not the processes in S03-S06 have been executed with respect to all the locations of the candidate positions A-D detected in the process in S02 (S07). If the processes in S03-S06 have been executed with respect to all the locations of the candidate positions A-D detected in the process in S02, a process in S08 is carried out. Whereas if the processes in S03-S06 are not yet executed with respect to all the locations of the candidate positions A-D detected in the process in S02, the operation loops back to the process in S03. Then, the processes in S03-S06 are repeated with respect to all the locations of the candidate positions A-D detected in the process in S02.

If the processes in S03-S06 have been executed with respect to all the locations of the candidate positions A-D detected in the process in S02, it is determined whether all the vias provided in the layout design target semiconductor device are redundancy-structured (dualized) or not (SO8) . If all the vias provided in the layout design target semiconductor device have been redundancy-structured, the redundancy-enabled candidate position data 15 is displayed on the display unit 7 (S09). Whereas if there exists the non-redundancy-structured via in the vias provided in the layout design target semiconductor device, the operation loops back to the process in S01.

Thus, the redundancy-enabled candidate positions are displayed on the display unit 7. Accordingly, the designer may chose the optimum position from within the redundancy-enabled candidate positions displayed on the display unit 7, and may dispose the new via in the chosen candidate position.

The design apparatus is capable of detecting the position, where the new via can be disposed, which position does not depart from the layout design before the check performed by the DRC. Then, the layout designer himself or herself can omit the operation of detecting the position where the new via is disposed in a way that refers to the design rule. Therefore, the layout design procedures can be reduced. Further, the multiplicity of redundancy-enabled vias can be detected in a short period of time, and a decrease in yield due to disconnection of the via can be prevented.

### <Computer Readable Recording Medium>

It is possible to record a program which causes a computer to implement any of the functions described above on a computer readable recording medium. By causing the computer to read in the program from the recording medium and execute it, the function thereof can be provided. The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM.

What is claimed is:

1. A design apparatus for a semiconductor device, comprising:
a unit generating a new-via-formable overlapped area between a first wiring pattern and a second wiring pattern by extending, in a predetermined direction, at least one of said first wiring pattern included in a first wiring layer of said semiconductor device and said second wiring pattern connected by a via to said first wiring pattern and included in a second wiring layer thereof; and
a unit determining whether or not there is a predetermined interval between said first extended wiring pattern and a wiring pattern existing in the periphery of said first wiring pattern in each of said first wiring layer including the first extended wiring pattern and said second wiring layer including said second extended wiring pattern, and determining whether or not there is a predetermined interval between said second extended wiring pattern and a wiring pattern existing in the periphery of said second wiring pattern.

2. The design apparatus for a semiconductor device according to claim 1, further comprising:
a unit recording, if there is the predetermined interval between said first extended wiring pattern and the wiring pattern existing in the periphery of said first wiring pattern, the new-via-formable overlapped area between said first wiring pattern and said second wiring pattern; and
a unit displaying the recorded new-via-formable overlapped area between said first wiring pattern and said second wiring pattern.

3. The design apparatus for a semiconductor device according to claim 1, wherein the predetermined direction includes a direction of 0 degree, a direction of 90 degrees, a direction of 180 degrees and a direction of 270 degrees to directions in which said first wiring pattern and said second wiring pattern are arranged.

4. A computer readable storage medium storing a design program for a semiconductor device executed by a computer, the design program comprising:
a step of generating a new-via-formable overlapped area between a first wiring pattern and a second wiring pattern by extending, in a predetermined direction, at least one of said first wiring pattern included in a first wiring layer of said semiconductor device and said second wiring pattern connected by a via to said first wiring pattern and included in a second wiring layer thereof; and
a step of determining whether or not there is a predetermined interval between said first extended wiring pattern and a wiring pattern existing in the periphery of said first wiring pattern in each of said first wiring layer including the first extended wiring pattern and said second wiring layer including said second extended wiring pattern, and determining whether or not there is a predetermined interval between said second extended wiring pattern and a wiring pattern existing in the periphery of said second wiring pattern.

5. The computer readable storage medium storing the design program for the semiconductor device according to claim 4, further comprising:
a step of recording, if there is the predetermined interval between said first extended wiring pattern and the wiring pattern existing in the periphery of said first wiring pattern, the new-via-formable overlapped area between said first wiring pattern and said second wiring pattern; and
a step of displaying the recorded new-via-formable overlapped area between said first wiring pattern and said second wiring pattern.

6. The computer readable storage medium storing the design program for the semiconductor device according to claim 4, wherein the predetermined direction includes a direction of 0 degree, a direction of 90 degrees, a direction of 180 degrees and a direction of 270 degrees to directions in which said first wiring pattern and said second wiring pattern are arranged.

7. A circuit design apparatus comprising:
a unit generating a new-via-formable overlapped area between a first wiring pattern and a second wiring pattern by extending, in a predetermined direction, at least one of said first wiring pattern included in a first wiring layer and said second wiring pattern included in a second wiring layer different from said first wiring layer, said first wiring pattern and said second wiring pattern being connected to each other by a via; and
a unit determining whether or not there is a predetermined interval between said extended wiring pattern and another wiring pattern existing in the periphery of said extended wiring pattern in said wiring layer including said extended wiring pattern.

8. The circuit design apparatus according to claim 7, further comprising:
a unit recording the overlapped area if there is the predetermined interval between said extended wiring pattern and said another wiring pattern; and
a unit displaying the recorded overlapped area.
